(19) United States
(12) Patent Application Publication
(10) Pub. No.: US 2009/0006042 A1
(43) Pub. Date: Jan. 1, 2009

(54) Method and system for generating a graphical representation of a space

(75) Inventor: Thibaud Flury, Pontcharra (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 12/150,432

(22) Filed: Apr. 28, 2008

(30) Foreign Application Priority Data
Apr. 26, 2007 (FR) 07/54730

(51) Int. Cl. G06F 17/50

(52) U.S. Cl. 703/1

(57) ABSTRACT

A graphical representation is generated on the basis of a database containing descriptors of localized entities, comprising information on said localized entities in a geometric model, a set-theoretic model and a semantic model. The method comprises the following steps: election (E2) of a reference entity by executing membership tests with regard to said given position with respect to the localized entities of the database with the aim of selecting a relevant localized entity containing said given position in accordance with at least one predefined relevance criterion; the reference entity being associated with a specific category of space in the semantic model, determination (E3) of the localized entities belonging to said localized reference entity and associated in the semantic model with the same category of space as that associated with the localized reference entity; and construction (E4) of the graphical representation of the space on the basis of the information on the entities determined in the previous step and contained in the database.

### RELATED APPLICATIONS

This application claims the priority of French application Ser. No. 07/54730 filed Apr. 26, 2007, the content of which is hereby incorporated by reference.

### FIELD OF THE INVENTION

The invention relates to a method for generating a graphical representation of a space as well as to a system for implementing the method.

### BACKGROUND OF THE INVENTION

Numerous applications call upon navigation tools making it possible to display a plan and to move around this plan by translation and/or rotation. The “plan” can be a graphical representation of space or else an aerial picture. The navigation tool generally offers the user various views:

close-up view of a particular zone of the plan, by zooming in, or

more general view of the plan, by zooming out.

In the event of zooming, the elements of the plan are usually not modified, only the proportion displayed changes. It is however sometimes possible to obtain further details by zooming.

The plans used by such navigation tools are pre-established and stored in memory in a database. It follows from this that these navigation tools have a limited adaptation capability, should the space represented be modified. For example, should a new street be constructed in a town, it is usually necessary to replace the entire plan of the town in order to update it in the database.

There also exist databases containing descriptors of localized entities, the descriptor of a localized entity comprising information on said localized entity in a geometric model, a set-theoretic model and a semantic model. Such databases exhibit the advantage of allowing easy adaptation, should the space represented be modified. Specifically, it suffices to update the descriptor of the localized entity or entities that are impacted by this modification. To return to the aforesaid example of constructing a new street in a town, it suffices to supplement the database with the descriptor of a new localized entity corresponding to this street.

Nevertheless, the plans generated on the basis of this type of database do not necessarily contain all the information relevant for the user, having regard to his position.

### SUMMARY OF THE INVENTION

One object of the invention is to generate plans, or more generally graphical representations of space, having a relevant level of detail for representing the environment related to a given position of a user for example.

This and other objects are attained in accordance with one aspect of the invention directed to a method for generating a graphical representation of a space in relation to a given position from a database containing descriptors of localized entities, comprising information on said localized entities in a geometric model, a set-theoretic model and a semantic model, comprising the steps of:

electing a reference entity by executing membership tests with regard to said given position with respect to the localized entities of the database with the aim of selecting a relevant localized entity containing said given position in accordance with at least one predefined relevance criterion;

the reference entity being associated with a specific category of space in the semantic model, determining the localized entities belonging to said localized reference entity and associated in the semantic model with the same category of space as that associated with the localized reference entity;

constructing the graphical representation of the space on the basis of the information on the entities determined in the previous step and contained in the database.

The invention makes it possible to dynamically generate a graphical representation of the space which is relevant in relation to the position considered, which is for example that of a user. By way of illustrative examples,

if the user is situated in a street, the method generates a graphical representation of the street and of the localized entities that it contains (shops, cinemas, restaurants, etc.),

if the user is situated in a shop, the method generates a graphical representation of the interior of the shop,

if the user enters a building, the method generates a graphical representation of the story of the building where he is situated comprising the various rooms and corridors of this story and their layout.

Advantageously, the step of electing the reference entity uses as relevance criterion the smallest entity containing the considered position. By virtue of this, the graphical representation generated corresponds to the environment of the position considered.

### BRIEF DESCRIPTION OF THE DRAWINGS

FIGS. 1A and 1B represent flowcharts of the various steps of a particular exemplary implementation of the method for generating a graphical representation of space according to the invention;

FIG. 2 represents a functional block diagram of a system for implementing the particular embodiment of the method of the invention, illustrated by the example of FIG. 1.

### DETAILED DESCRIPTION OF THE DRAWINGS

The method and the system 2 of the invention are aimed at generating a graphical representation of a space in relation to a given position. In the particular example described by way of illustration, the considered position is that of a user moving in a town.

The method comprises a prior step E0 of storing descriptors of a plurality of localized entities in a database 1 that is linked to the system 2 of the invention. The expression “localized entity” is understood to mean an arbitrary element having a determinable position in space at a given instant. By way of illustrative examples, it may involve a person (stationary or moving), a sensor, a town, a street, a room, walls, a floor, etc. A localized entity can also be a reference frame. This reference frame can itself be determined with respect to another reference frame, that is to say another localized entity. The descriptor of a localized entity comprising information on said localized entity in several models, in this instance a geometric model, a set-theoretic model and a semantic model. It would be possible to envisage calling upon other models.

The geometric model makes it possible to associate a geometric abstraction with a localized entity, namely a point or a shape. In the first case (point-wise abstraction), the entity is represented by a point. In the second case (shape abstraction), it is represented by a geometric shape such as a polygon, a polyhedron, a parametrized surface, etc.

The geometric model also makes it possible to define an information cue for locating the localized entity. In the particular example of the description, the geometric model is subdivided into three distinct sub-models: the “Metric” sub-model, the “Cartesian” sub-model and the “Euclidean Affine” sub-model.

The Metric sub-model makes it possible to model the distances between localized entities. The distance between two entities is modeled by the distance between the centers of the shape geometric abstractions and/or the points of the point-wise abstractions.

The Cartesian sub-model defines a system of Cartesian coordinates, stated otherwise a Cartesian reference frame, making it possible to tag a point in space with respect to a Cartesian frame of reference. This frame of reference comprises an origin, consisting of a fixed point of the space, and three orthogonal axes. In a Cartesian reference frame, the position of a localized entity can thus be defined by Cartesian coordinates with respect to the frame of reference considered. This Cartesian sub-model therefore makes it possible to define the position of an entity localized in a Cartesian reference frame.

The Euclidean Affine sub-model defines an affine space comprising at least one pivot affine frame of reference and a plurality of other affine frames of reference related to the pivot frame of reference by equations for changing frame of reference. This affine sub-model, richer than the Cartesian sub-model, makes it possible to define transformations (translation, rotation, etc.) between various reference frames. This affine sub-model makes it possible to define a configuration as a tree of reference frames, linked to one another by affine transformations (translations, homotheties, central symmetries, etc.). With each reference frame are associated one or more localized entities. Conversely, each localized entity can be associated with its own reference frame, it being possible for the latter to itself be linked to another reference frame by an affine transformation.

The reference frames themselves constitute localized entities described in the database 1. In the example described here, the database 1 stores the descriptor of the WGS 84 reference frame, well known in the field of location. This is in fact a fixed worldwide reference frame used by the GPS positioning system. Here towns have their own reference frame described with respect to this WGS 84 reference frame. Each street also possesses its own reference frame described with respect to the reference frame of the town to which it belongs. The premises, shops and other buildings of a street can also be associated with their own respective reference frames described with respect to the reference frame of this street.

The set-theoretic model is based on mathematical set theory, created initially by the German mathematician Georg Cantor, at the end of the XIX^{th} century. The basic concepts of set theory are the notions of element, set and membership. According to this theory, a set is formed through the union of basic objects, or elements, which belong to this set. Stated otherwise, a set is considered to be a collection of elements that it contains. A set can itself be considered to be an element in order to form a new set. Thus, one set can contain another. Two sets can also partially overlap, stated otherwise exhibit a nonzero intersection, or else be disjoint. The operations of union, intersection and complement make it possible to create new sets. Finally, a set can also be divided into subsets.

In the location context, the set-theoretic model makes it possible to describe the structure of space. In this model, a localized entity corresponds to a basic element or to a set itself containing subsets or basic elements. Let us take the example of a building constituting a localized entity. In the set-theoretic model, the building is a set subdivided into subsets corresponding respectively to various localized entities such as rooms, corridors, stories, etc.

The set-theoretic model thus makes it possible to define relations of membership, intersection, union, complement and subdivision between localized entities corresponding to elements or sets, according to set theory, so as to describe the structure of the space. To return to the example of a town, in the database 1, the “town” entity contains “street” entities, stated otherwise each “street” entity belongs to the “town” entity. The “street” entities contain entities “lampposts”, “shops”, “premises”, etc. The “shops” entities contain departments.

The role of the semantic model is to associate a meaning, a semantic representation, with each localized entity. This model divides the space into various categories, that may be dubbed taxonomies, respectively associated with specific semantics, that may be called ontologies. In the particular example described here, the following space categories are used: urban category, architectural category, territorial administration category.
The category “architectural” divides the space into buildings, stories, rooms, corridors and lifts;
the category “urban” divides the space into streets, squares, towns, pavements, shops, etc;
the category “urban planning” which comprises entities relating to the urban planning such as lampposts, parking slots, containers, etc;
the category “territorial administration” divides the space into countries, regions, counties, towns, etc.

Furthermore, in the semantic model, a localized entity is not only associated with a category of space but also with semantic properties specific to this category, in particular with one or more semantic qualifier(s) representative of the nature of the localized entity (for example buildings, stories, rooms, street, shop, etc.). By way of illustrative example, a shop can possess a name, a proprietor, a characterization, products and/or services sold, etc.
Thus, a localized entity's descriptor stored in the database 1 comprises: information on the localized entity in the geometric model comprising
   a geometric abstraction (shape or point),
   possibly one or more distances between the localized entity considered and other localized entities,
   the position of the localized entity in a reference frame (this reference frame itself being able to constitute a localized entity and be described by an affine transformation with respect to another reference frame);
information on the localized entity in the set-theoretic model comprising indications on the relations existing between the localized entity considered and one or more other localized entities (relations of membership, non-membership or nonzero intersection,) or else the constructing of localized entities by operations on sets (operations of intersection, union, complement, etc.);
information on the localized entity in the semantic model comprising the indication of the category of space to which the entity belongs (here architectural, urban or territorial administration) and of the semantic properties specific to this category of the space, in particular one or more qualifiers defining the nature and identifying the localized entity considered.

By way of illustrative example of information in the set-theoretic model, consider a building with stories. Each story of the building is formed through the union of its rooms and of its corridors and the building itself is formed through the union of its stories. A user situated in a room of the building “belongs” to this room and, by construction, this room “belongs” to the building.

By way of illustrative example of information in the semantic model, consider an office in a building. This office is defined in the semantic model by the architectural category and dubbed “room” and “office”. A name of the proprietor of the office can also be specified.

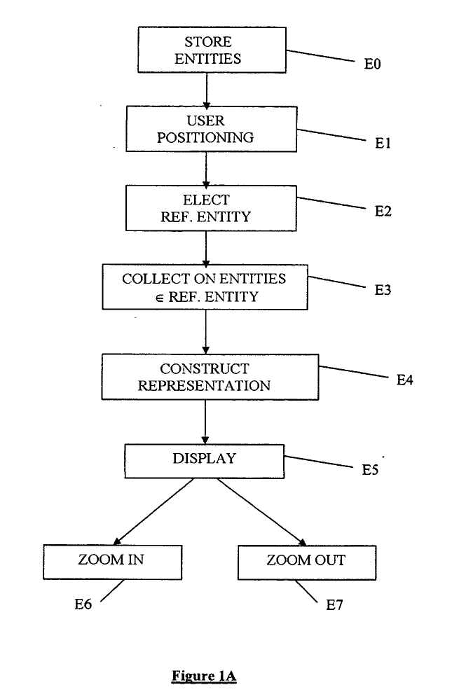

The method for generating a graphical representation of a space in relation to a given position on the basis of the database 1 will now be described with reference to FIG. 1.

Let us continue with the example of the user moving in a town, and more precisely in a shopping street, that will be called the street “ALPHA”. In a first phase, it will be considered that the user is walking along the street ALPHA and, in a second phase, that he enters a shop, that will be called the shop “BETA”.

The method of the invention proposes to generate graphical representations of the space with respect to the various positions of the user while moving. The aim is to provide this user with relevant information on his environment as a function of his position. It is assumed that the position of the user is known at each instant by virtue of location means. In the example described here, these location means comprise a positioning system 3, integrated within an item of portable equipment of the user, for example an item of equipment 4 of suitable personal digital assistant PDA type. The positioning system 3 is able to provide at each instant the coordinates of the user in the WGS 84 reference frame. It would be possible however to envisage any other type of location technique, for example an intra-building location technique using wireless networks.

First Phase in the Street

During this first phase in the street, during a step E1, the positioning system 3 provides the coordinates of the user in the WGS 84 reference frame at an instant t1. These coordinates define the position P1 of the user at the instant t1.

Step E1 of positioning the user is followed by a step E2 of electing a reference entity by executing a succession of tests of set-theoretic membership of the position P1 with respect to the localized entities of the database. The purpose of these membership tests is to select a relevant localized entity containing said position P1 in accordance with at least one relevance criterion. In the example described here the relevance criterion is that of the smallest entity containing the given position (P1). In the course of this step E2, the system 2 therefore carries out tests of set-theoretic membership of the position P1 of the user with respect to the localized entities of the database 1, on the basis of the information on said localized entities in the set-theoretic model. In the case where the membership relations between all or some of the localized entities considered are not stored in the database 1, the system 2 performs tests of geometric membership to deduce therefrom the set-theoretic membership. On completion of these membership tests, the system 2 selects the smallest localized entity containing the position P1. The search could be optimized by set-theoretic relations already stored in the database 1. In the example described, the search step E2 culminates in selecting the street ALPHA as smallest entity of the database 1 containing the position P1 of the user. The street ALPHA, which is the localized entity selected during step E2, constitutes what will subsequently be called the “localized reference entity”.

The localized reference entity, the street ALPHA, is associated with a specific category of space in the semantic model, in this instance the urban category. In a step E3, the system 2 collects information relating to the localized entities belonging to the localized reference entity (the street ALPHA), and associated in the semantic model with the same category of space as that associated with the localized reference entity, namely the urban category.

This step E3 decomposes into three sub-steps E30 to E32. In the first sub-step E30, the system 2 searches through the database 1 for the localized entities also belonging to the street ALPHA, that is to say to the localized reference entity. The system 2 thus identifies in the database 1 all the localized entities which are directly contained in the reference entity (the street ALPHA), otherwise which belong to (directly) the street ALPHA. Between the reference entity (street ALPHA) and the identified localized entities, there must exist a set-theoretic relation of direct membership. Each localized entity identified by the search belongs to the reference entity (street ALPHA), without intermediate entity between the reference entity and the identified entity containing the identified entity and belonging to the reference entity. In this instance, the localized entities identified during this step E3 comprise the trafficway, shops, premises and lampposts localized in the street ALPHA. It would also be possible to envisage that step E3 makes it possible to identify the people localized in the street ALPHA.

After sub-step E30 of searching for and determining the localized entities belonging to the reference entity (street ALPHA), there is provided a filtering sub-step E31 consisting in filtering the localized entities identified during sub-step E30 so as to retain only those associated in the semantic model with the same category of space as that associated with this localized reference entity, namely the urban category. On completion of this filtering, only the trafficway, the shops and the premises determined in step E30 are retained. The lampposts, although belonging to the street ALPHA, are filtered, stated otherwise not retained, because they are associated with the urban planning category.

The filtering sub-step E31 could be carried out before step E30 of searching for and determining the localized entities belonging to the reference entity, or concomitantly with the latter.

It will be stressed that this filtering sub-step E31 makes it possible to retain only the relevant entities, stated otherwise those appropriate for the object aimed at by generating a plan, or graphical representation of the space, which is to provide the user only with useful information to allow him to get his bearings in space, to identify his surroundings and guide him in his movements, without polluting the plan with not very useful or indeed useless details.

The last sub-step E32 of step E3 consists in collecting the information relating to the entities identified in sub-step E30 and retained following the filtering E31, in the three models used here, namely the geometric model, the set-theoretic model and the semantic model.

Step E3 is followed by a step E4 of constructing a graphical representation of the space surrounding the user on the basis of the information, collected in step E3, relating to the localized entities belonging to the reference entity (street ALPHA) and associated with the same category of space as that of this reference entity (urban category), namely the trafficway, the premises and the shops of the street ALPHA. This information comprises information in the geometric, set-theoretic and semantic models. Thus, the graphical representation constructed on the basis of the position P1 of the user comprises the trafficway, the premises and the shops of the street ALPHA. This representation is displayed to the user on the screen of his PDA equipment 4, during a step E5.

Second Phase in the Shop

Thereafter it is considered that the user enters one of the shops of the street ALPHA, that will subsequently be called the shop BETA.

The steps described previously in relation to the first phase in the street are then repeated, with the difference that the position of the user has changed. Specifically, the latter is henceforth situated inside the shop BETA. For the sake of clarity, the new steps described below and referenced E1′ to E4′ correspond to steps E1 to E4 described previously and only the differences between corresponding steps are described hereinafter.

In the positioning step E1′, the positioning system 3 provides the coordinates of the user at an instant t2, corresponding the new position P2 of the user in the shop BETA. It will be noted that this position P2 could be defined with respect to a reference frame specific to the shop BETA, which is itself defined with respect to the reference frame of the street by an affine transformation.

In step E2′, on the basis of this new position P2, the system 2 carries out a succession of tests of set-theoretic membership of the position P2 with respect to the localized entities of the database 1 until it selects the shop BETA, on the basis of the criterion of the smallest localized entity containing the position P2. The shop BETA is thus considered, during the second phase, as the localized reference entity.

It will be noted here that the localized reference entity “shop BETA” is associated with the “architectural” category of space in the semantic model.

In step E3′, the system 2 determines the localized entities belonging to the reference entity “shop BETA” and associated in the semantic model with the same category of space as that associated with the shop BETA, namely the architectural category, and collects the information on these entities in the geometric, set-theoretic and semantic models. In this instance, the localized entities determined in step E3′ comprise departments of the shop, fitting cubicles, toilets and a payment till.

In step E4′, the system 2 constructs, generates a graphical representation of the space surrounding the user on the basis of the information collected on the entities determined in step E3′ (departments, fitting cubicles, toilets and payment till). Thus, the graphical representation constructed on the basis of the position P2 of the user comprises the departments, fitting cubicles, toilets and payment till of the shop BETA, disposed in accordance with the configuration of the interior of the shop BETA. This representation is displayed on the screen of the user's PDA equipment 4 in step E5′.

In the above description, in step E2 (E2′), the system 2 performs a succession of membership tests so as to determine the smallest localized entity containing the position considered and to elect this entity as “reference entity”. As a variant, a relevance parameter, called the “Relevance Indication” and denoted RI, is allocated to each localized entity in the database. This parameter is here binary, it being possible for its value to be “YES” or “NO”, and it forms part of the information relating to the localized entity in the semantic model. If, for a given entity, this relevance parameter is activated, the information cue “RI=YES” is associated with the entity in the database 1. This signifies that the entity considered is able to play the role of reference entity. On the other hand, if, for a given entity, the relevance parameter is not activated, the information cue “RI=NO” is associated with the entity in the database 1. In this case, the entity considered is able to play the role of reference entity. In this variant embodiment, step E2 (E2′) of determining a reference entity comprises a sub-step E20 (E20″) of determining the smallest entity e₀ containing the position considered followed by a step E21 (E21′) of verifying the relevance parameter RI. If RI(e₀)=YES, the smallest entity determined in step E20 e₀ is elected reference entity. On the other hand, if RI(e₀)=NO, step E21 is followed by a step E22 of determining the smallest entity e₁ to which the smallest non-relevant entity e₀ previously determined belongs. A step E23 thereafter verifies the parameter RI of this entity e₁. If RI(e₁)=YES, the entity e₁ constituting the smallest relevant entity is elected reference entity. On the other hand, if RI(e₁)=NO, steps E22 and E23 are repeated (as many times as necessary) to find the smallest entity eₓ containing the position considered and for which RI(eₓ)=YES. By way of illustrative example, in this variant embodiment, a prohibited parking slot in a street is a localized entity for which the relevance parameter is not activated, stated otherwise RI=NO. It would also be possible to envisage using another, non-binary, parameter characterizing the localized entity.

The system of the invention makes it possible to generate various graphical representations of a given space. These representations, or plans, can be classified according to a tree of graphical representations, the apex of the tree corresponding to the most general view of the space considered and the representations of the bottom of the tree corresponding to detailed close-up views of particular zones of the space. Such a tree derives, that is to say is deduced, from the relations between the localized entities, stored in the base 1, but is not here stored as such in the base 1. It ultimately constitutes a graph of set-theoretic relations.

Consider a tree of graphical representations of a given space, for example a town. This tree comprises

a representation corresponding to a general view of the space considered (general view of the town, in the example cited), at the apex, that is to say at the highest level of the tree, and

representations corresponding to increasingly close-up views of particular zones of the town (districts, streets, shops, etc.) in the lower levels of the tree, the views being ever closer-up towards the lower levels.

It is recalled that these representations are not stored as such but constructed dynamically on the basis of zoom in or out commands from the user.

The representation generated in step E4 and displayed in step E5 corresponds to a certain level of the tree, dependent on the position of the user. The display step E5 (E5′) can be followed by a step E6 (E6′) of “zoom in”, that is to say of generating, or of constructing, a graphical representation of the space of lower level than that of the representation generated in step E3 (E3′). This step E6 (E6′) comprises the following sub-steps:
selecting by the user of one of the localized entities contained in the graphical representation displayed, stated otherwise in the reference entity;
determining the localized entities belonging to the localized entity selected in the previous sub-step and associated in the semantic model with the same category of space as that associated with said selected localized entity;
constructing the graphical representation of the lower level space on the basis of the information relating to the localized entities determined in the previous sub-step and contained in the database

The display step E5 (E5′) can also be followed by a step E7 (E7′) of “zoom out”, that is to say of generating, or of constructing, a plan of higher level than that of the representation generated in step E3 (E3′). This step E7 (E7′) comprises the following sub-steps:
selecting a localized entity containing the elected localized reference entity, corresponding to the representation of the space displayed in step E5 (E5′), for example by selecting from a pop-up menu offered to the user by the system;
determining the localized entities belonging to the localized entity selected in the previous sub-step and associated in the semantic model with the same category of space as that associated with said selected localized entity;
constructing the graphical representation of the higher level space on the basis of the information relating to the localized entities determined in the previous sub-step and contained in the database.

It would also be possible to envisage displaying on the same screen graphical representations of the space of various levels, for example the street ALPHA with its trafficway, its premises and its shops, including the shop BETA, as well as the interior of the shop BETA with its departments, its fitting cubicles, its toilets and its payment till.

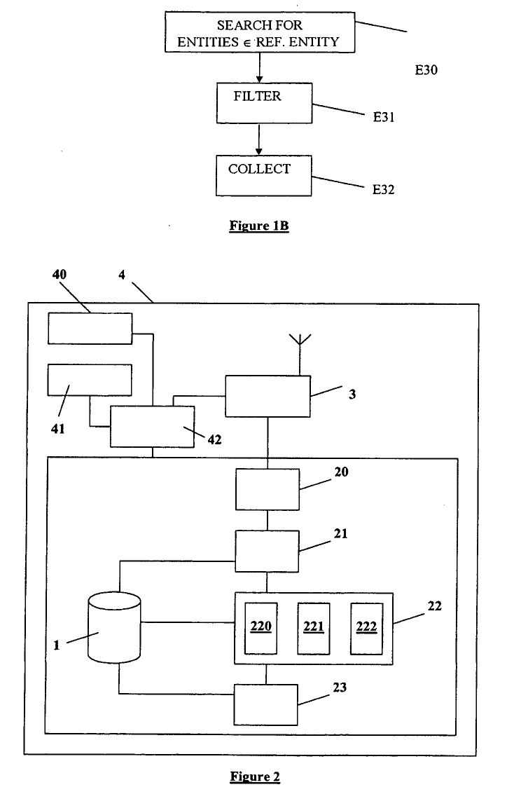

The method described is implemented by a system 2, represented in FIG. 2. In the example described here, this system 2 is integrated within the equipment 4 of the user, furnished with the positioning module 3. The system 2 is suitable for generating a graphical representation of a space in relation to a given position on the basis of a database 1, here internal to the system 2, containing descriptors of localized entities. These descriptors comprise information on the localized entities in a geometric model, a set-theoretic model and a semantic model.

In addition to the database 1, the system 2 comprises:
a module 20 for collecting positioning information here relating to the user, connected to the positioning module 3;
a module 21 for electing a reference entity by executing tests of set-theoretic membership of the position obtained by the reception module 20 with respect to the localized entities of the database with the aim of selecting a relevant localized entity containing said given position in accordance with at least one predefined relevance criterion;
   the reference entity being associated with a specific category of space in the semantic model, a module 22 for determining localized entities belonging to said localized reference entity and associated in the semantic model with the same category of space as that associated with the localized reference entity;

a module 23 for constructing the graphical representation of the space on the basis of the information on the entities determined and retained by the module 22, contained in the database 1.

The modules 21, 22 and 23 are linked to the database 1.

In the example of FIG. 2, the system 2 contains the database 1. As a variant, the latter could be external to the system 2 and linked to it by communication means.

The module 20 for collecting positioning information here comprises linking means for communication with the positioning module 30 of the terminal 3. It would be possible to envisage the positioning module being external to the terminal 3 and linked to the latter for example through a telecommunications network.

The module 22 comprises
a block 220 for searching for and determining the localized entities belonging to the reference entity elected by the module 21;
a filtering block 221 for retaining, from among the entities determined by the block 220, only those belonging to the same category of space as the reference entity,
a block 222 for collecting the information on the entities retained by the block 221 in the database 1.

The modules 21, 22 and 23 described above are here software modules forming a computer program. The invention also relates therefore to a computer program for the equipment 4 comprising software instructions for implementing the method previously described when the program is executed by the equipment. The program can be stored in or transmitted by a data medium. The latter can be a hardware storage medium, for example a CD-ROM, a magnetic diskette or a hard disk, or else a transmissible medium such as an electrical, optical or radio signal.

The equipment 4 comprises in particular, in a conventional manner, a screen 40, entry means 41, comprising here an entry keyboard and a touch screen, and a central control unit 42, in this instance a micro-processor. All the elements of the equipment 4, including the system 2 for generating graphical representations, are linked to the central control unit, which is intended to control the operation of these elements.

The system 2 which has just been described could be integrated within any other device (for example a server) of a telecommunications network, comprising means for acquiring positioning information for one or more localized entities (the localized entities possibly being users or other entities capable of moving). The means for acquiring positioning information on the localized entities considered can correspond to positioning means or means for acquiring this positioning information from positioning means external to the device, through a network. The invention therefore also relates to a device comprising means for acquiring positioning information for a localized entity and the system which has just been described.

1. A method for generating a graphical representation of a space in relation to a given position from a database containing descriptors of localized entities, comprising information on said localized entities in a geometric model, a set-theoretic model and a semantic model, wherein the method comprises the steps of:
electing (E2) a reference entity by executing membership tests with regard to said given position with respect to the localized entities of the database with the aim of selecting a relevant localized entity containing said given position in accordance with at least one predefined relevance criterion;
the reference entity being associated with a specific category of space in the semantic model, determining (E3) the localized entities belonging to said localized reference entity and associated in the semantic model with the same category of space as that associated with the localized reference entity; and
constructing (E4) the graphical representation of the space on the basis of the information on the entities determined in the previous step and contained in the database.

2. The method according to claim 1, wherein the step (E2) of electing the reference entity uses as relevance criterion the smallest entity containing the considered position.

3. The method according to claim 2, wherein a localized entity being associated with a relevance parameter indicating whether the entity is or is not able to play the role of reference entity, during the step of electing the reference entity (E2), the smallest entity containing the position considered and for which the associated relevance parameter indicates that it is able to play the role of reference entity is determined.

4. The method according to claim 1, comprising:
a step (E7) of generating a graphical representation of the space of higher level than that of the previously generated representation, wherein the step of generating a graphical representation comprises the sub-steps of:
selecting a localized entity containing the previously elected localized reference entity;
determining the localized entities belonging to the localized entity selected in the previous sub-step and associated in the semantic model with the same category of space as that associated with said selected localized entity; and
to constructing the graphical representation of the higher level space on the basis of the information relating to the localized entities determined in the previous sub-step and contained in the database.

5. The method according to claim 1, comprising:
a step (E6) of generating a graphical representation of the space of lower level than that of the previously generated representation wherein the step of generating a graphical representation comprises the sub-steps of:
selecting a localized entity contained in the elected localized reference entity;
determining the localized entities belonging to the localized entity selected in the previous sub-step and associated in the semantic model with the same category of space as that associated with said selected localized entity; and
constructing the graphical representation of the lower level space on the basis of the information relating to the localized entities determined in the previous sub-step and contained in the database.

6. A system for generating a graphical representation of a space in relation to a given position on the basis of a database containing descriptors of localized entities, comprising information on said localized entities in a geometric model, a set-theoretic model and a semantic model, wherein the system comprises:
means (21) for electing a reference entity by executing membership tests with regard to said given position with respect to the localized entities of the database with the aim of selecting a relevant localized entity containing said given position in accordance with at least one predefined relevance criterion;
the reference entity being associated with a specific category of space in the semantic model, means (22) for determining localized entities belonging to said localized reference entity and associated in the semantic model with the same category of space as that associated with the localized reference entity; and
means (23) for constructing the graphical representation of the space on the basis of the information on the determined entities, contained in the database.

7. A unit comprising the system of claim 6 and a database (1) containing descriptors of localized entities, comprising information on said localized entities in a geometric model, a set-theoretic model and a semantic model.

8. A device (4) comprising means for acquiring positioning information for a localized entity and the system according to claim 6.

9. A computer program for a system for generating a graphical representation of a space in relation to a given position on the basis of a database containing descriptors of localized entities, comprising information on said localized entities in a geometric model, a set-theoretic model and a semantic model, comprising software instructions for controlling the execution of the steps of the method according to claim 1, when the program is executed by a computer.

10. A recording medium readable by a computer on which the computer program according to claim 9 is recorded.
